(19) United States
(12) Patent Application Publication
(10) Pub. No.: US 2011/0231549 A1
(43) Pub. Date: Sep. 22, 2011

(54) SYSTEMS AND METHODS FOR CONTROLLING ACCESS TO THE INTERNET AND OTHER SERVICES PROVIDED BY A NETWORK

(76) Inventor: Tom C. Tovar, San Francisco, CA (US)

(21) Appl. No.: 12/897,474

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 15/173

(52) U.S. Cl. 709/225

(57) ABSTRACT

Systems and methods for controlling access to the Internet and other services provided by a network, such as a home network, are described. Exemplary systems may receive input from a user of a network and disable access to the Internet based on the input. In some embodiments, the systems automatically disable access to the Internet when certain conditions are satisfied, such as the occurrence of a time period for disabling access to the Internet.

### CROSS-REFERENCE TO RELATED APPLICATION(S)

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### TECHNICAL FIELD

The present application is directed to systems and methods that mediate access to the Internet or other service provided by networks.

### BACKGROUND

People set up an Internet service and/or associated access network in their home or office in generally one of two different configurations, an unsecured or open configuration or a secured or protected configuration. The unsecured or open configuration facilitates access to all users, regardless of their association with the Internet service (or wireless network facilitating access to the Internet service). The secured or protected configuration prevents unwanted users from accessing the Internet service by requiring users to provide access credentials (e.g. a password) before being permitted to access the service. Although a user can assign such security levels to their Internet service to prevent undesirable use, current systems do not provide other functionalities or configurations that may be desirable to users with respect to their networks.

The need exists for systems and methods that overcome the above problems, as well as provide additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a block diagram illustrating an exemplary system for controlling access to the Internet provided by a network in accordance with various embodiments of the present invention.

FIG. 2 is a flow diagram illustrating an exemplary method for controlling access to the Internet.

FIG. 3 is a flow diagram illustrating an exemplary method performed by a DNS server for controlling access to a service provided by a network.

FIG. 4 is a flow diagram illustrating an exemplary method for scheduling access to a service provided by a network.

FIGS. 5A-5D are display diagrams illustrating example screen shots presented by various embodiments of the present invention.

FIG. 6 is a block diagram illustrating an exemplary Internet service system in accordance with various embodiments of the present invention.

FIG. 7 is a block diagram illustrating an exemplary system for controlling access to the Internet in accordance with various embodiments of the present invention.

FIG. 8 is a block diagram illustrating an exemplary computing environment for controlling Internet access on a network in accordance with various embodiments of the present invention.

### DETAILED DESCRIPTION

### Overview

Systems and methods for controlling access to a service, such as the Internet, provided by a network are described. An exemplary system, which may be an application running on a device that communicates with a DNS server associated with the service, allows users to turn off their Internet resolution manually or automatically. The system manages and/or controls access to the network of a user, allowing the user to dictate when the network is to be available, among other benefits.

In some embodiments, the system may receive requests to disable or otherwise control access to a service provided by the network, transmit the received requests to a controlling server, and modify the access to the service. In some cases, the system may receive the requests directly from a user associated with the network, such as an owner, resident, or the like. In some cases, the system may receive information from a user associated with scheduling time periods in which access to the service should be disabled or otherwise modified. In some cases, the system may receive information associated with a user and disable or otherwise modify access to the service based on the received information. For example, the system may receive information associated with a location of a user, historical access information for the user and/or other users, or other conditions associated with disabling the service, and modify access accordingly.

Typical ways of restricting access to a network may not provide users with sufficient ability to control their Internet and/or their network, as current methods suffer from various drawbacks. For example, passwords are often used to authorize users on a network and merely provide security benefits, while manually shutting off a network (i.e., unplugging a wireless router) can prevent others from getting on a network, but is a cumbersome process. The present invention, however, may assist users in controlling access to their Internet.

The following description provides specific details for a thorough understanding and enabling description of various embodiments of the invention. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the system. Certain terms may even be emphasized below; however, any terminology intended to be interpreted in any restricted manner will be overtly and specifically defined as such in this Detailed Description section.

Generally speaking, an administrator may create and enforce value-based mediation polices for one or more end users that utilize computing devices coupled to an Internet service delivered to a location such as a home, residence place of business or campus. The term “administrator” may include not only individuals, such as parents, but also any individual creating value-based mediation policies regarding the Internet service delivered to end users. It will be understood that an administrator may also be an end user, although end users who are not also administrators may not create or apply mediation policies.

It will be further understood that because of the diversity of computing devices that may connect to the Internet service, the mediation policy may be applied to the Internet service rather than requiring the mediation policy to affect each computing device individually, such as a mediation application resident on each computing device. In various exemplary embodiments a value-based mediation policy may also reside as a stand alone application on one or more of the computing devices.

Exemplary user devices for use with the disclosed systems may have a user interface. In various embodiments, such as those deployed on personal mobile devices, the user interface may be, or may execute, an application, such as a mobile application (hereinafter referred to as an “app”). An app may be downloaded and installed on a user's mobile device. Users may define a mediation policy via a user device, such as through the user interface. Some embodiments of the present invention do not require software to be downloaded or installed locally to the user device and, correspondently, do not require the user to execute a de-install application to cease use of the system.

Controlling Access to the Internet or to other Services

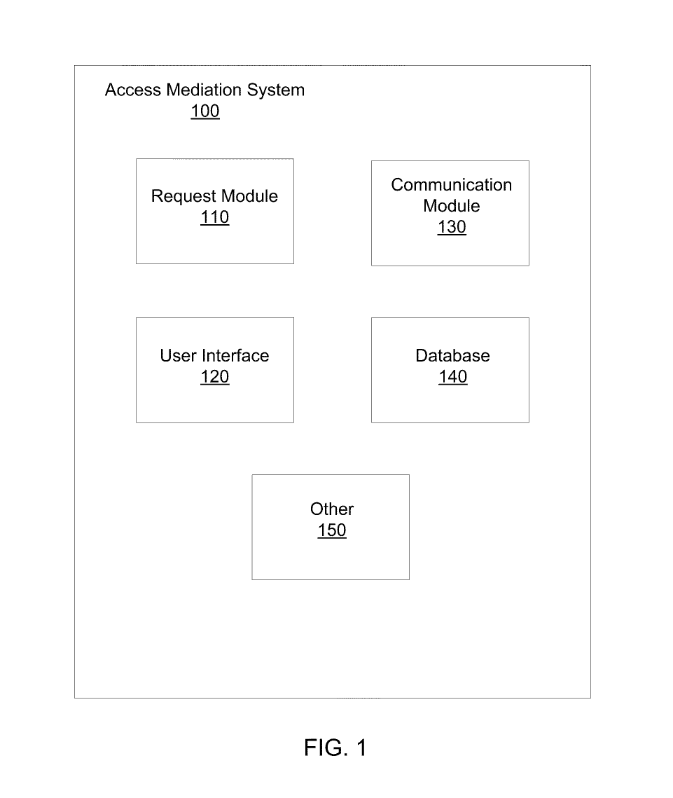

As discussed herein, the system in some embodiments enables users of the network to control access to the networks and provided services. FIG. 1 is a block diagram illustrating a system 100 for mediating access to the Internet provided by a network. The system 100 and/or some or all of its components 100 may reside within a mobile device, tablet, laptop, server, or other computing devices. For example, the system 100 may include components within an application downloaded to and running on a mobile device, such as a Smartphone, as well as components located at a server, such as a DNS server, in communication with an Internet service. The system 100 may interact with a DNS network, Internet service, and/or other entities and devices that manage communications between devices and services provided by a network, such as a wireless network. Further details regarding components of the system and/or suitable computing environments and devices are discussed herein.

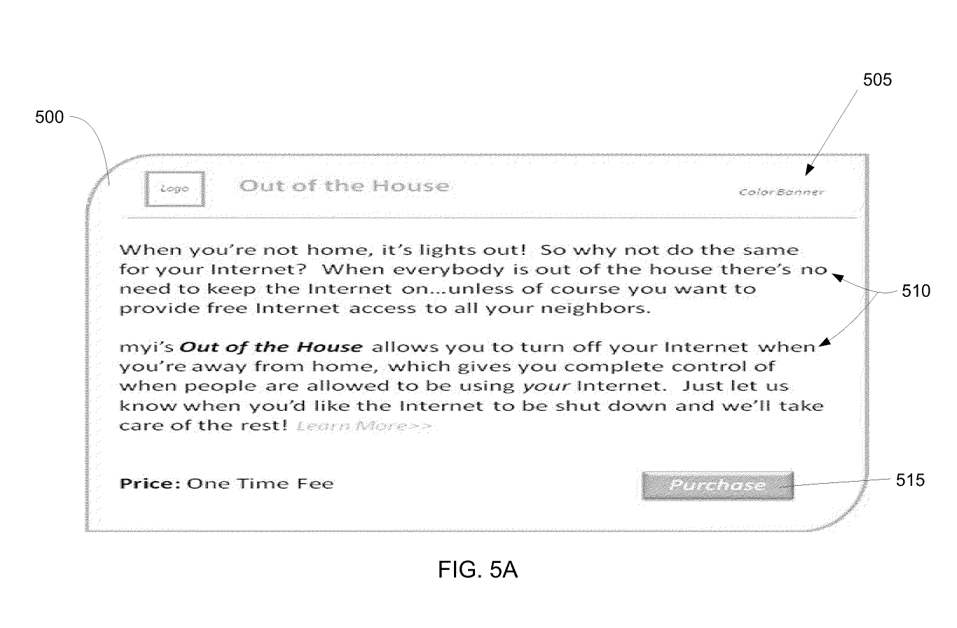

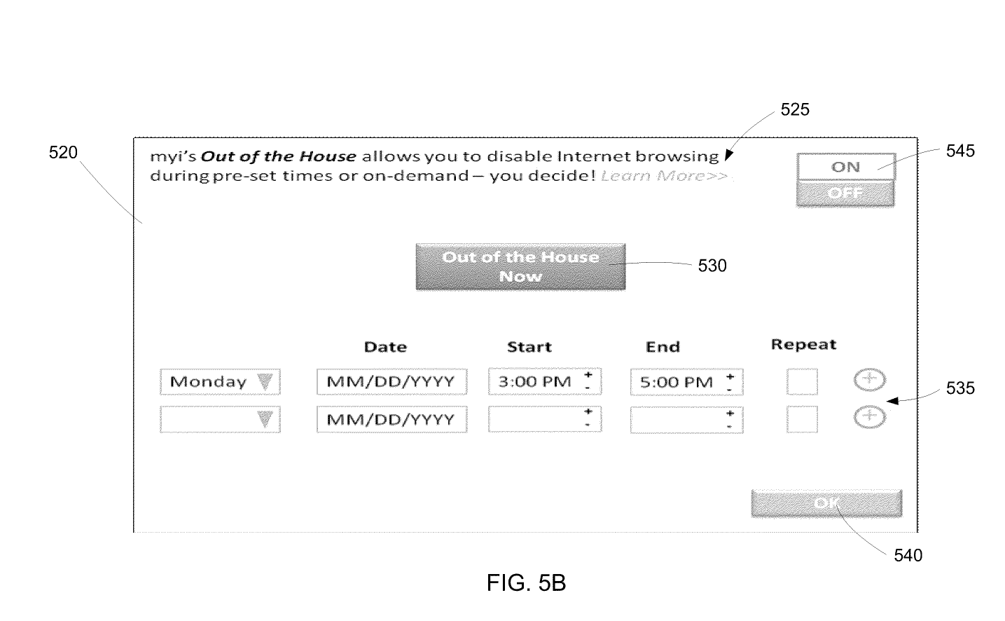

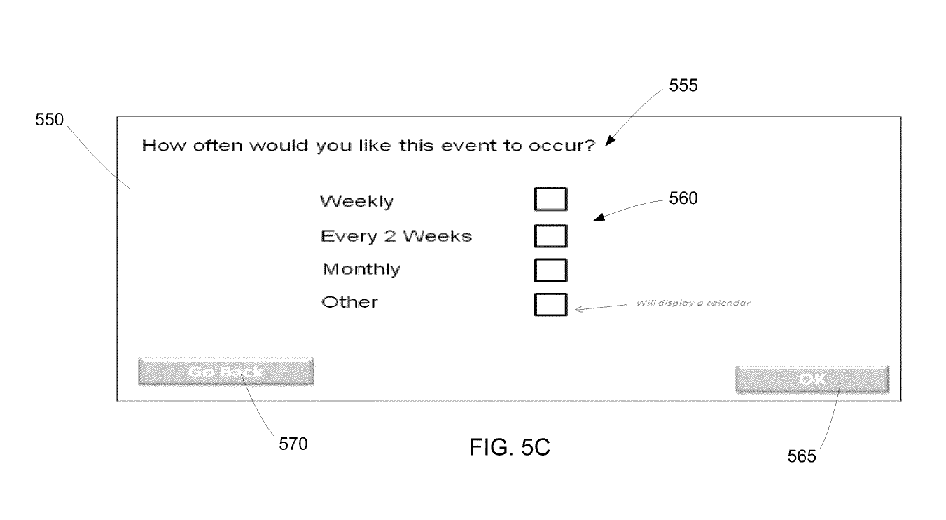

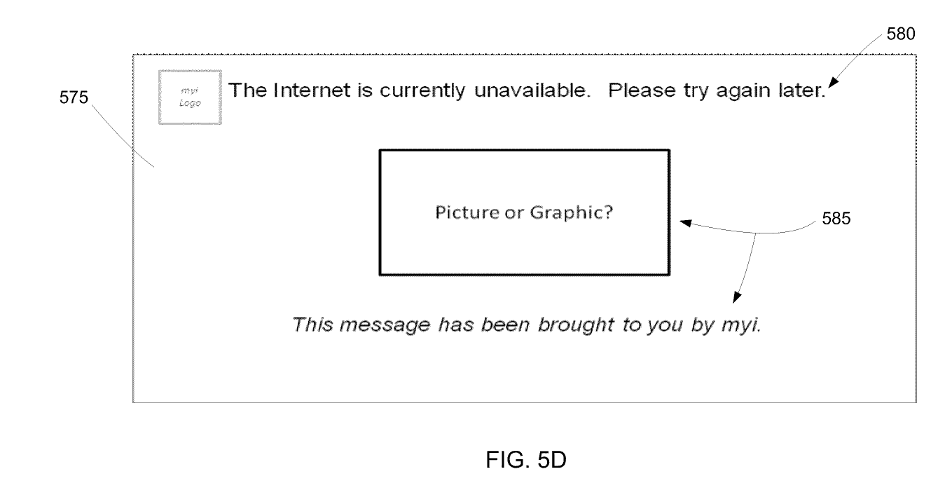

The system 100 may include a request module 110 configured to receive requests to control access to a network and/or services provided by the network, such as the Internet. In some cases, the request module 110 may receive requests from users of mobile devices to disable or enable access to the network and/or provided services, such as requests received via a user interface presented by a user interface module 120. The user interface module 120 may be configured to present one or more user interfaces to a user via a display of a computing device associated with the user. The user interfaces presented by the user interface module 120 may include information to be presented to the user, graphical elements that facilitate reception of information from a user, and so on. Further details regarding presented user interfaces will be discussed with respect to FIGS. 5A-5D.

In some cases, the request module 110 receives requests associated with scheduled access control of the network and/or provided services, such as requests from a scheduling or calendaring module. The scheduling or calendaring module (not shown) may store information identifying time periods in which to enable access or disable access to the network and/or provided services.

The system 100 may also includes a communication module 130 configured to transmit and/or communicate information from a device associated with a user to a server associated with controlling the access to the network and/or services provided by the network. The communication module 130 may utilize various different communication devices when transmitting information, including but not limited to radios, Bluetooth components, RF components, and/or other wireless transmission components.

The system 100 also includes a database module 140 configured to store information and other data for the system. For example, the database module 140 may store information associated with displayed user interfaces, information associated with the user or the device of the user, information associated with manual access control requests, information associated with automatic access control requests (such as scheduling information), and so on.

Of course, the system 100 may include or interact with other modules 150. For example, the system 100 may interact with various processing components, memory components, location determination components, calendaring components, downloaded applications, social networking sits, and so on.

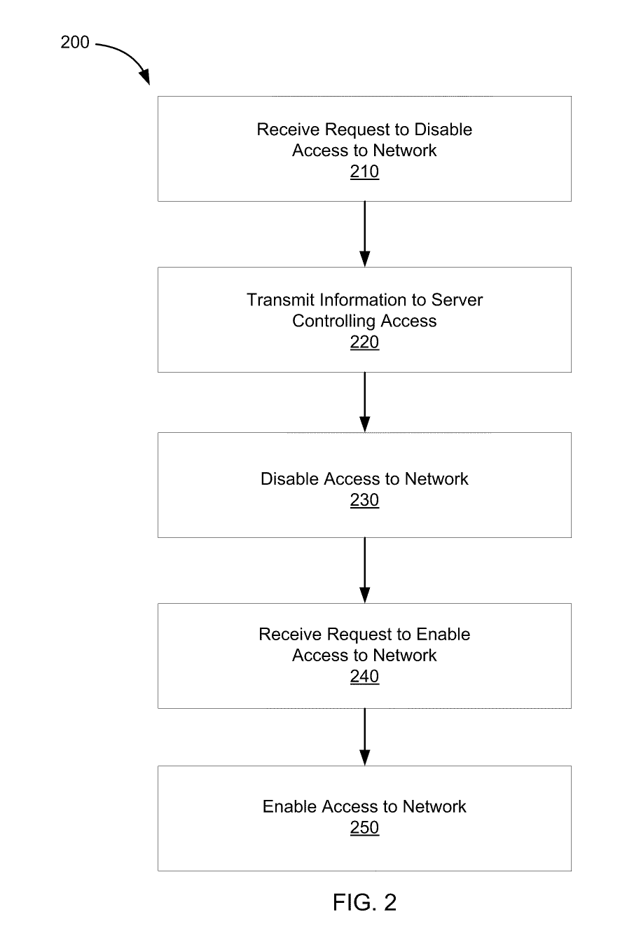

FIG. 2 is a flow diagram of an exemplary method 200 for controlling access to the Internet. In step 210, the system may receive a request to disable access to a network or services provided thereon. The system may receive the request directly from a user, such as by receiving input from a user via a graphical user interface presented by a display of a mobile device associated with the user. The user may establish predefined or automatic requests, such as scheduled requests, that automatically initiate disabling access to the network or provided services. Further details regarding automatically initiated requests will be discussed below.

In step 220, the system may transmit information to a remote server that facilitates access to the Internet and other services. The system may transmit information to an Internet server, a DNS server, or other systems and devices that manage access to and interactions with the Internet and other services provided by a network.

In step 230, the system may disable access to the Internet or other provided services. That is, the system may prohibit users from accessing the Internet, although the system does not necessarily shut off a wireless network or other services. The system may, instead of connecting a user device with the Internet, redirect a browser of the user device to a single web page hosted by the system that indicates the Internet is currently temporarily disabled. In some cases, the system may send or transmit alerts or indications to a user confirming that access has been disabled.

In step 240, the system may receive a request to facilitate or reestablish access to the Internet or other provided services. In some cases, the system receives a request directly from a user, such as a homeowner that purchased and/or set up the home network. In some cases, the system receives notification from a scheduling component indicating a time period associated with disabled access has ended.

In step 250, the system may enable or reestablish access to the Internet and other provided services. In some cases, the system sends out or transmits alerts or indications to a user confirming that access has been enabled. Thus, in some embodiments, the system enables users to control when their Internet and other network services are available to themselves and others, effectively acting as an on/off switch for the Internet, among other things.

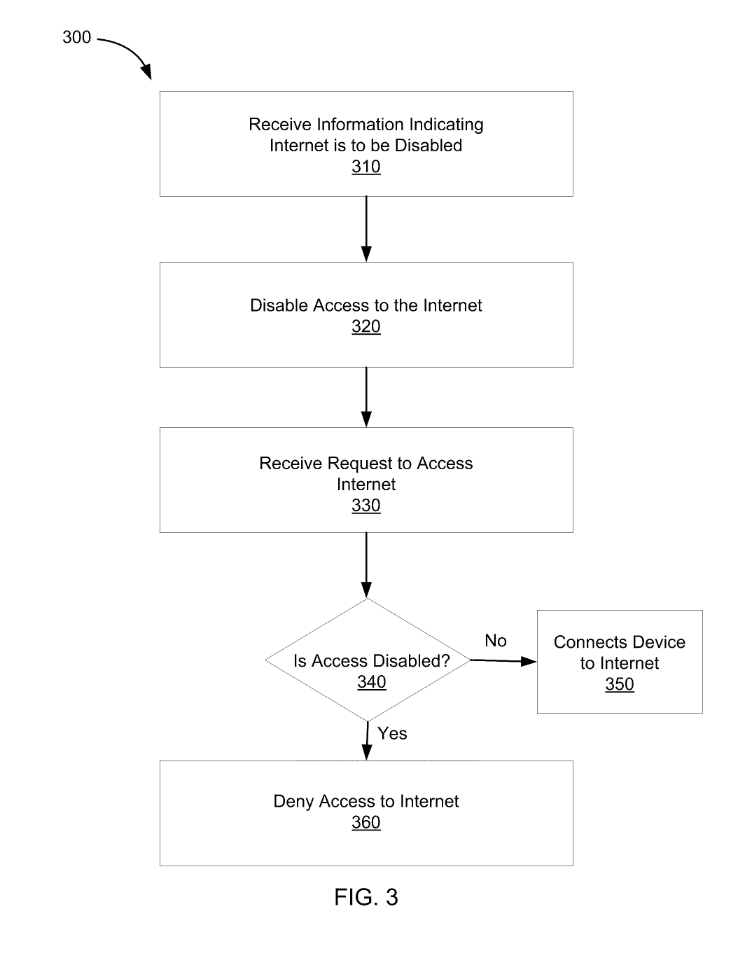

As discussed herein, a server (e.g., a DNS server) or service (e.g., an Internet service) may include some or all of the components used to control access to the Internet via a network, such as a wireless network. FIG. 3 is a flow diagram illustrating a routine 300 performed by a DNS Server or Internet service for controlling access to a service provided by a network.

In step 310, the server may receive information indicating the Internet is to be disabled. For example, the server may receive information from an application, running on a mobile device associated with a user, that facilitates the reception of input from the user. Based on the received information, the server, in step 320, may disable access to the Internet.

In step 330, the server may receive a request from a user to access the Internet. For example, the server may receive the request from a different user, such as a user outside of a home providing the network and access to the Internet. In step 340, the server may determine if access to the Internet is disabled. When the server determines that access is not disabled, routine 300 proceeds to step 350 and connects the requesting device to the Internet. When the server determines that access is disabled, routine 300 proceeds to step 360, and denies access to the Internet.

In denying access, the routine 300 at step 360 may provide an indication that access has been denied. The server may redirect the request to access the Internet to a web page hosted by the server that indicates that access is disabled. The server may simply end the connection, may provide a list of other available Internet locations (i.e. a list of locations sponsored by the Internet Service Provider), and so on.

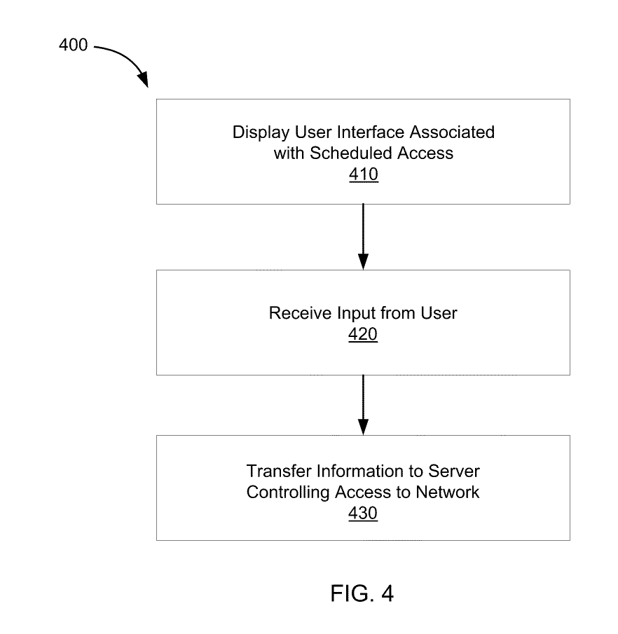

As discussed herein, the system, in some embodiments, facilitates the automatic scheduling of disabling and enabling access to a network and the services provided. FIG. 4 is a flow diagram illustrating a routine 400 for scheduling access to a service provided by a network.

In step 410, the system may display a user interface associated with scheduled access to services provided by the network. The user interface, discussed in greater detail with respect to FIGS. 5A-5D, may be displayed by a user device, such as a mobile device, laptop, tablet, and so on.

In step 420, the system may receive via the user interface input from a user associated with the scheduled access. For example, the system may receive input identifying daily time periods (e.g. typical working hours) in which to disable access to the Internet on the network of the user.

In step 430, the system may transfer the information to a server that controls access to the services provided by the network. The system may store the information as a table or other data structure in one or more databases associated with the user, the user device, the network, the services, and so on. The system, at the server level, may then access the stored information in order to determine when to disable access to provided services. For example, the server may access the data structure represented by Table 1 in order to determine the time periods in which to enable/disable the Internet service of a given user:

TABLE 1

| Time Period | Access? |
|---|---|
| 0:00-8:00 | Yes |
| 8:01-18:30 | No |
| 18:31-11:59 | Yes |

Of course, other data structures may be employed by the system.

In addition to scheduled access control of a network and services provided by the network, the system in some embodiments employs other routines and/or devices in order to provide automated access control. That is, the system may utilize information received from a variety of different sources to determine whether certain conditions satisfy conditions associated with disabling or enabling access to the network and provided services.

The system may utilize information from a location component of a user device, such as a GPS component, and control access based on location information received from the location component. For example, the system may utilize a GPS component to determine that the user device associated with a user is no longer at home, indicating a likelihood that the user is also not at home, and disable access to the network. The system may utilize other information in making similar determinations, such as information received from a calendar associated with the user (i.e. the calendar of the user indicates the user is traveling to another city), information indicating the user has accessed a network different from the system network or is at a location remote from the system network (i.e., the user “checks in” at the local coffee shop using a social networking site), and so on.

In some embodiments, the system may selectively disable services provided by the network upon receiving a request from a user. For example, the system may disable access to all services that provide data communications over a network (such as the Internet) while maintaining access to all services that provide voice communications over the network. Thus, a user may still be able to place or receive calls on the network without having access to data and other services.

As discussed herein, the system may display various user interfaces in order to receive and/or provide information to a user at a user device. FIGS. 5A-5D are display diagrams illustrating example screen shots presented by various embodiments of the present invention.

FIG. 5A depicts a user interface 500 the system may present before a user purchases access to the system. The user interface 500 may include a logo or other branding elements 505, information elements 510 describing services provided by the system, buttons 515, and other input elements that facilitate purchases or requests for more information, and so on.

For example, the system presents the user interface 500 in response to receiving a request from a user to purchase or find out more information about the system and provided functionalities. Via the input element 515, the system may receive input from a user indicating a desire to purchase the system. In response to the received input, the system may navigate to and present user interfaces that facilitate registering users, user interfaces that facilitate receiving payment information, and so on.

FIG. 5B depicts a user interface 520 that the system may utilize to receive a request to control access to a network and provided services. The user interface 520 may include informational elements 525 that describe the functionality of the system, input elements 530 that receive direct requests from users to disable/enable a network or provided services, input elements 535 that receive requests to set up automated access controls, navigational element 540, input elements 545 that enables/disable the system, and so on.

For example, the system presents the user interface 520 in response to receiving a request from the user to launch the system. Once launched, the system, in response to a selection of element 530, disables access to the Internet. The system may also facilitate the scheduling of time periods in which to enable/disable the Internet via the input element 535. For example, the input element 535 facilitates receiving date and time information associated with periods of disablement, as shown. Upon receiving a selection of input element 540, the system may store the user selections, and disable the Internet accordingly. The system, via input element 545, also facilitates receiving user input regarding the activation of the system. The navigation element 540 (such as an exemplary button labeled “OK”) allows for a user to indicate to the system that the user has completed inputting data regarding disabling the Internet via the user interface 520. According to certain embodiments, the navigational element 540 may indicate to the system that the user's inputted settings are to be saved. In various embodiments, the navigational element 540 may indicate that a next user interface should be displayed to the user.

FIG. 5C depicts a user interface 550 the system may utilize to set up automated requests, such as events. The user interface 550 may include informational elements 550 that query users regarding the details of access control events, input elements 555 that receive information from users, navigational elements 560, and so on.

For example, the user interface 550 may provide information 555 to a user, such as a query, and receive a selection answering the query via element 560. The system may receive a selection of a reoccurring time period in which to disable access to the Internet (weekly, monthly, and so on), or may receive a selection regarding a discrete time period (other). The user interface also provides navigation elements 565 and 570 that, when selected, navigate a user to a previous user interface or to a following user interface.

FIG. 5D depicts a user interface 575 the system may utilize when indicating that access to a service or network is disabled. The user interface 575 may include informational elements 580 indicating access is disabled, branding elements 585 that may indicate the service disabling the access, and so on.

For example, a different user such as a neighbor of the user, may attempt to access the Internet during a time period in which the Internet is disabled. In response to the attempt, the system may intercept the access attempt and present the user interface 575, providing information 580 that the Internet is not available and/or information 585 about the system (such as information identifying the system that has generated the message indicating to the user that Internet access has been disabled).

Of course, the system may utilize other user interfaces and graphical elements not shown in the figures, such as user interfaces that alert users to the automatic disabling of a network or associated services, user interfaces that alert a user to conditions that might warrant disabling of the network or associated services, navigational user interfaces, user interfaces that facilitate purchasing, registration, or downloading of applications and other services provided by the system, and so on.

### Example Scenarios

The following examples described various scenarios in which some or all aspects of the system may be employed. Other examples are of course possible.

A frequent traveler launches an application associated with the system on her mobile device before leaving for the airport. The system, via the application, presents the traveler with user interface 520, and receives input from the user via element 530 requesting that the system disable the Internet in her home. The system, upon receiving the request, transmits information to a server controlling access to services provided by the network, and the server disables the services.

An office worker uses the system to automatically disable the Internet at their house between the hours of 9:00 AM to 6:00 PM. The worker launches an application on their tablet computer and inputs the desired time period for disabling access to the Internet. The system, upon receiving the input, generates database entries associated with the received time periods, and disables the Internet at the home of the office worker during those time periods. A housekeeper comes to the house at 10:00 AM every Friday to clean the house, although he typically spends half the time instant messaging friends on his laptop. He attempts to access the Internet, and is directed to user interface 530, which informs him that access to the Internet is disabled (and he should get to work). Later, the office worker's teenage son comes home at 5:00 PM and attempts to access the Internet. The son is supposed to do homework until 6:00 PM, but based on the schedule provided by the office worker, he is also denied access to the Internet.

When setting up the system, a young professional provides instructions to disable the Internet at her home when the system receives or retrieves information from a social networking site associated with the professional that indicates the professional is not at home. On a given day, the professional rushes out of the houses to get to a meeting at a coffee shop, and forgets her Smartphone. She “checks in” at the coffee shop using a social networking site. The system, monitoring her social networking site, identifies the location of the professional to be the coffee shop, and disables the Internet at her home.

### Suitable Systems

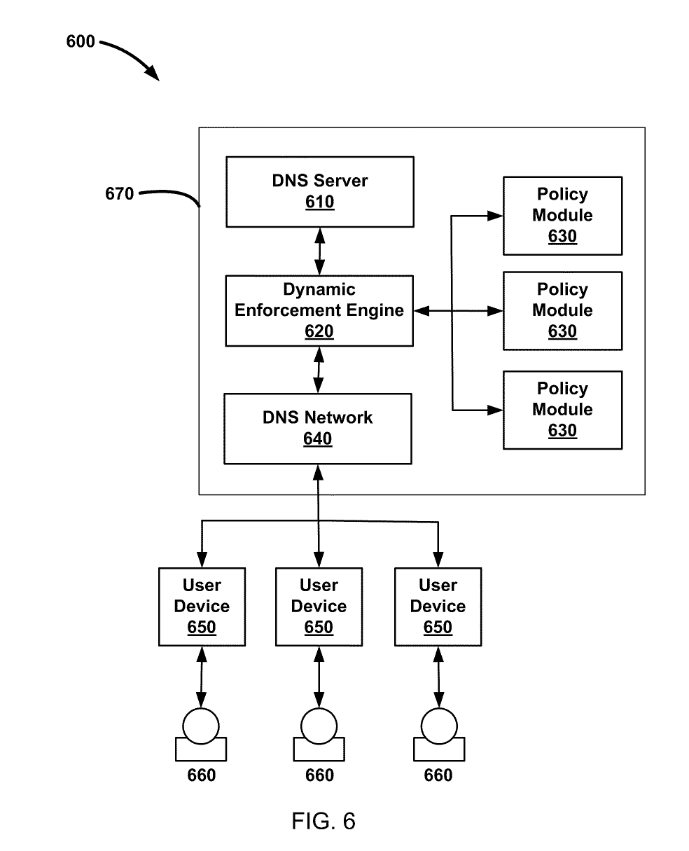

As discussed herein, the system 100 and/or various components may reside or interact with an Internet service or a DNS network. For example, components of the system 100 and/or routines described herein may be implemented in plug-in utilities, gateway devices, cable modems, proxy servers, set top boxes, network interface devices, and so on. FIG. 6 is a block diagram illustrating a suitable Internet service system 600 in accordance with various embodiments of the present invention.

A DNS server 610 operates in conjunction with a dynamic enforcement engine 620. The dynamic enforcement engine 620 may operate in conjunction with one or more policy modules 630 to establish any applicable polices at the DNS server 610 level. The content rules are applied to received user queries, and determine the content that is delivered by the DNS network 640 through various user devices 650 to the end users 660.

The dynamic enforcement engine 620 may generate its policy engine on instructions received from one or more policy modules 630. Each policy module 630 may be constructed to provide various types and levels of services to the DNS network 640. In some embodiments, a policy module 630 may be configured to handle queries directed to subjects including, but not limited to, malicious domain redirection, user access redirection, non-existent domain redirection, and data collection or analysis.

It will be recognized by those skilled in the art that the elements of DNS service 670 may be hosted either locally or remotely. In addition to residing in the DNS service 670, one or more of the DNS network 640, the dynamic enforcement engine 620, and the policy modules 630, and any combination thereof, may be resident on one or more user devices 650.

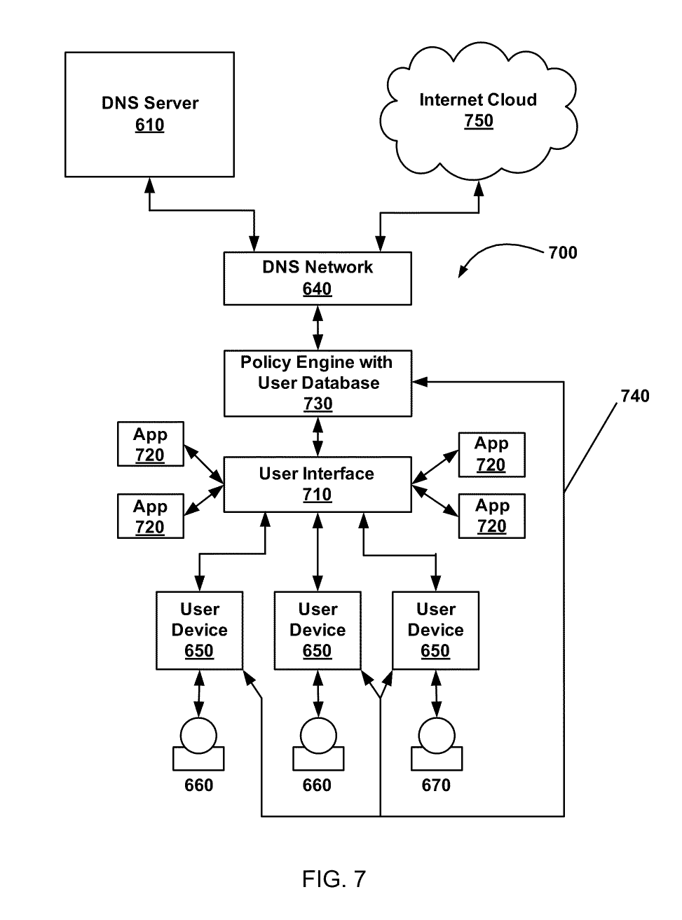

FIG. 7 is a block diagram illustrating a suitable system 700 for controlling access to the Internet in accordance with various embodiments of the present invention. The system 700 may operate on a DNS server 610 or within a cloud based architecture 750.

The system 700 presents a user interface 710, such as the user interfaces described herein, to one or more users 660 via user devices 650 associated with the users 660. For example, the system may present a web page. The users 660 may access the user interface 710 via a gateway user device 650. Example user devices include desktops, PCs, laptops, notebooks, tablets, gaming devices, music player, Smartphones, and other mobile devices, automobile computer systems, Internet enabled TVs, and so on. Users may also access and/or control the system 700 remotely via user devices 650, such as Smartphones, or other mobile devices with computing capabilities, such as capabilities associated with accessing the Internet.

The user interface 710 provides a mechanism for one or more authorized users 660 to control access to the network and/or provided services. The user interface 710 operates between the user devices 650 present in the system 700 and the DNS network 640. Instructions resident on the user interface 710, therefore, operate on the Internet service, by controlling at least a portion of DNS resolutions via a dynamic policy engine 730, before the service reaches the displays of the user devices 650.

The user interface 710 provides the users 660 with access to one or more policy or access control applications 720. The user interface 710 may provide access to a selection list for at least one authorized user 660. The authorized user 660 uses the selection list or some other menu mechanism to select those policy or access control applications 720 that the user 660 chooses to apply to the system 700. The authorized user 660 may select any number of the available policy applications for use on the system 700 at any given time. In implementations utilizing Smartphones as the user device 650, the policy applications 720 are downloaded to the user device 650. The user device 650 then serves as the user interface 710 to communicate directly with the dynamic policy engine 730.

The policy or access control applications 720 may disable access to the network or provides services. For example, the policy applications 720 may limit the time of day when users or selected users 660 may access the Internet. The policy applications 720 may also manage and analyze the duration of access to various sites. It is important to note that the policy applications 720 do not simply provide blocking mechanisms by masking or enabling network controls, but rather mediate an Internet service received by the end user. As used herein, mediating the service may include any of blocking, constraining, enabling, redirecting, promoting, demoting, substituting, obscuring, limiting, interrupting, disabling, and/or restricting all or a portion of the Internet service or other provided services. The policy applications 720 may provide notifications or alerts to one or more users 660 when sites are accessed. The policy applications 720 may also provide notification of frequency and duration of access of designated sites. The policy applications 720 may also be used to observe, substitute, enable, redirect users, to reward behavior desired from the users by a system administrator, and so on. The policy applications 720 may redirect users from a non-favored site to another site. The policy applications 720 may also collect and transmit data characteristic of Internet use.

Access policies supplied by the policy applications 320 may apply to all users 660 of the system 700, or the access policies may be specific to individual users or groups of users 660. The policy applications 720 may be discrete, single purpose applications.

The policy applications 720 provide the users 660 with a mechanism to take various actions relative to their Internet service feed. The policy applications 720 also allow the users 660 to establish a dynamic policy engine 730 that includes a user database. The policy engine 730 is used to enforce rules associated with each policy application associated with individual end users, not simply block various inappropriate sites from the Internet feed. Rather, the dynamic policy engine 730, controlled by the user interface 710 through user device(s) 650, is used to manage all aspects of the Internet experience for the users 660. In sum, the policy applications 720 may be used to configure the dynamic policy engine 730 to provide the users 660 with a mechanism to personalize the Internet experience. The policy applications 720 may be configured in combinations, and may each be separately configured.

The database in the policy engine 730 may be used to record and to notify users 660 of various data relative to Internet access. The data collected from and provided to the users 660 may include records of access of specific sites, time spent on specific sites, time of day of access, data specific to individual users, and so on.

In some cases, after an initial setup through the user interface 710 of the policy engine 730, the system 700 may establish a direct access 740 enforcement loop between the policy engine 730 and the user devices 650. Subsequent accessing of the DNS network 640 utilizing the direct access 740 decreases response time in the system 700, thereby further enhancing the Internet experience of the users 760. Configurations of policy applications 720 that are selected by one or more users 660 designated as system administrators may remain in the user database of the policy engine 730 until such time as it may be modified by the system administrators. The system administrators may define multiple policy configurations, with a combination of policy applications 720, applicable to one or more end users 660 of the system 700. Each policy application 620 may be separately configurable as well. Policy configurations may vary based upon designated times, conditional triggers, or specific requests from the users 660 with administrative authority.

As indicated above, the system 700 may establish at least two discrete data flow paths. A first data path establishes a set of enforcement policies for the system 700. The first data path flows from at least one user device 650 through the user interface 710, to the policy enforcement engine 730. A second data path 740 may be utilized following the establishment of a set of policies for the system 700. The second data path 740 flows directly between the user device(s) 650 and the policy engine 730. Multiple sets of enforcement policies may be established and saved within the system 700 and implemented selectively by the users 660.

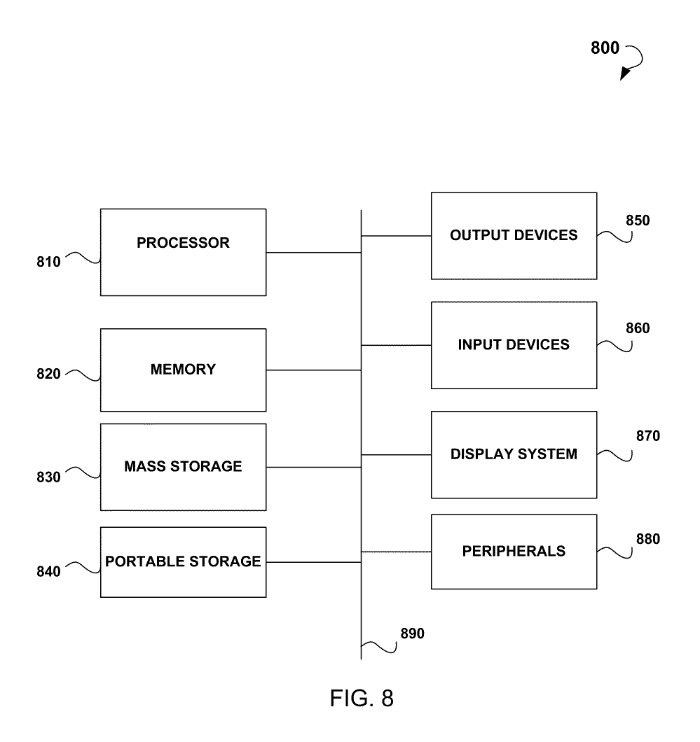

FIG. 8 is a block diagram illustrating a suitable computing environment for controlling Internet access on a network in accordance with various embodiments of the present invention. The system 800 may be implemented in the context of the system 100, the user devices 650, the DNS server 610, the Internet cloud 650, and so on. The computing system 800 includes one or more processors 810 and memory 820. The main memory 820 stores, in part, instructions and data for execution by processor 810. The main memory 820 may also store the executable code when the system 800 is in operation. The system 800 of may also include a mass storage device 830, portable storage medium drive(s) 840, output devices 850, user input devices 860, a display component 870, and other peripheral devices 880.

The components are shown are depicted as being connected via a single bus 890. The components may be connected through one or more data transport means. The processor unit 810 and the main memory 820 may be connected via a local microprocessor bus, and the mass storage device 830, peripheral device(s) 880, portable storage device 840, and display system 870 may be connected via one or more input/output (I/O) buses.

The mass storage device 830, which may be implemented with a magnetic disk drive or an optical disk drive, is a non-volatile storage device for storing data and instructions for use by processor unit 810. The mass storage device 830 can store the system software for implementing embodiments of the present invention for purposes of loading that software into the main memory 810.

The portable storage device 840 operates in conjunction with a portable non-volatile storage medium, such as a floppy disk, compact disk, or Digital video disc, to input and output data and code to and from the computer system 800. The system software for implementing embodiments of the present invention may be stored on such portable media and input to the computer system 800 via the portable storage device 840.

The input devices 860 provide a portion of a user interface. The input devices 460 may include an alpha-numeric keypad, such as a keyboard, for inputting alpha-numeric and other information, or a pointing device, such as a mouse, a trackball, stylus, or cursor direction keys. Additionally, the system 800 includes output devices 850. Suitable output devices include speakers, printers, network interfaces, and monitors.

The display system 870 may include a liquid crystal display (LCD) or other suitable display device. The display system 870 receives textual and graphical information, and processes the information for output to the display device.

The peripherals 880 may include any type of computer support device to add additional functionality to the computer system. Peripheral device(s) 880 may include a modem or a router.

The components contained in the computer system 800 are those typically found in computer systems that may be suitable for use with embodiments of the present invention and are intended to represent a broad category of such computer components that are well known in the art. Thus, the computer system 400 of FIG. 4 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

### CONCLUSION

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” encompasses any content that may be accessed by an Internet access user device and may include but not be limited to one or more of web sites, domains, web pages, web addresses, hyperlinks, URLs, any text, pictures, and/or media (such as video, audio, and any combination of audio and video) provided or displayed on a web page, and any combination thereof. As used herein restriction may include any of blocking, constraining, enabling, redirecting, promoting, demoting, substituting, obscuring, limiting, and interrupting.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method to mediate access to an Internet service, the method comprising:
providing instructions defining one or more restricted time periods during which access to an Internet service at a selected location provided by a network is to be disabled, the instructions being provided by an administrator associated with the network;
receiving a request from an end user device to access any Internet content,
determining whether the request is made during a restricted time period; and
denying the request if the request is made during a restricted time period, and resolving the request if the request is made during an unrestricted time period.

2. The method of claim 1, wherein the administrator provides instructions from a mobile device.

3. The method of claim 2, wherein the mobile device is associated with a second network.

4. The method of claim 1, wherein at least one element of the restriction policy is resident on a DNS server.

5. The method of claim 1, wherein at least one element of the restriction policy is enforced by a DNS server.

6. The method of claim 1, wherein the administrator specifies different restriction polices for different locations.

7. The method of claim 1, wherein elements of the Internet service reside on a user device.

8. The method of claim 3, further comprising receiving information from a GPS component of the mobile device indicating the mobile device is remote from the network associated with the administrator.

9. The method of claim 1, wherein the restricted time periods repeat based on a time interval, the time interval being selected from among a day, a week, and a year.

10. The method of claim 1, wherein the administrator establishes restricted time periods with no advanced notice.

11. The method of claim 1, wherein the administrator disables access to all Internet content with no advance notice.

12. The method of claim 1, wherein the administrator allows access to the Internet service during a restricted time period.

13. The method of claim 1, further comprising transmitting an alert to one or more administrators that access to the Internet service is disabled.

14. The method of claim 1, wherein the administrator is notified of any request made to access Internet content during a restricted time period.

15. The method of claim 1, wherein the administrator defines an exception list to maintain access to services providing voice communications over the network during a restricted time period.

16. The method of claim 1, wherein disabling access to the Internet service provided by the network includes disabling access to services providing data communications over the network.

17. The method of claim 1, further comprising presenting a notification screen stating that access to the Internet service is unavailable when a user attempts to access Internet content during a restricted time period.

18. The method of claim 1, wherein a history of restricted time periods and attempts to access Internet content during restricted time periods is stored and is accessible for processing, analysis, and reporting.

19. A system to mediate access to an Internet service, the system comprising:
a user interface module to provide a user interface between at least one application user and an Internet service; and
a request module to receive instructions defining one or more restricted time periods during which access to the Internet service provided by a network is to be disabled, the instructions being provided by an administrator associated with the network, so that when a request is received from an application user via the user interface to access Internet content, the system determines whether the request is made during a restricted time period, and denies the request if the request is made during a restricted time period, and resolves the request if the request is made during an unrestricted time period.

20. The system of claim 19, wherein the administrator provides instructions from a mobile device.

21. The system of claim 20, wherein the mobile device is associated with a second network.

22. The system of claim 21, further comprising receiving information from a GPS component of the mobile device indicating the mobile device is remote from the network associated with the administrator.

23. The system of claim 19, wherein the restricted time periods repeat based on a time interval, the time interval being selected from among a day, a week, and a year.

24. The system of claim 19, wherein the restricted time periods are established on an ad hoc basis by the administrator.

25. The system of claim 19, wherein the administrator disables access to Internet content with no advance notice.

26. The system of claim 19, wherein the administrator allows access to the Internet service during a restricted time period.

27. The system of claim 19, wherein at least one element of the restriction policy is resident on a DNS server.

28. The system of claim 19, wherein at least one element of the restriction policy is enforced by a DNS server.

29. The system of claim 19, wherein the administrator specifies different restriction polices for different locations.

30. The system of claim 19, wherein elements of the Internet service reside on a user device.

31. The system of claim 19, further comprising transmitting an alert to one or more administrators that access to the Internet service is disabled.

32. The system of claim 19, wherein the administrator is notified of any request made to access Internet content during a restricted time period.

33. The system of claim 19, wherein access to services providing voice communications over the network is maintained during a restricted time period.

34. The system of claim 19, wherein disabling access to the Internet service provided by the network includes disabling access to services providing data communications over the network.

35. The system of claim 19, further comprising presenting a notification screen stating that access to the Internet service is unavailable when a user attempts to access Internet content during a restricted time period.

36. The system of claim 19, further comprising establishing restricted time periods that vary according to the individual end user accessing the Internet service.

37. The system of claim 19, wherein a history of restricted time periods and attempts to access Internet content during restricted time periods is stored and is accessible for processing, analysis, and reporting.

38. A non-transitory machine-readable medium comprising instructions, which when implemented by one or more processors, perform the following operations:
providing instructions defining one or more restricted time periods during which access to an Internet service provided by a network is to be disabled, the instructions being provided by an administrator associated with the network;
receiving a request from an end user to access Internet content,
determining whether the request is made during a restricted time period; and
denying the request if the request is made during a restricted time period, and resolving the request if the request is made during an unrestricted time period.

39. A method to mediate access to an Internet service, the method comprising:
providing instructions defining one or more restricted time periods during which access to an Internet service provided by a network is to be disabled, the instructions being provided by an administrator associated with the network via a DNS server;
receiving a request at the DNS server from an end user device to access any Internet content,
determining whether the request is made during a restricted time period; and
denying the request if the request is made during a restricted time period, and resolving the request via the DNS server if the request is made during an unrestricted time period.

40. The method of claim 39, wherein the administrator provides instructions from a mobile device.

41. The method of claim 40, wherein the mobile device is associated with a second network.

42. The method of claim 41, further comprising receiving information from a GPS component of the mobile device indicating the mobile device is remote from the network associated with the administrator.

43. The method of claim 39, wherein the restricted time periods repeat based on a time interval, the time interval being selected from among a day, a week, and a year.

44. The method of claim 39, wherein the administrator establishes restricted time periods with no advanced notice.

45. The method of claim 39, wherein the administrator disables access to all Internet content with no advance notice.

46. The method of claim 39, wherein the administrator allows access to the Internet service during a restricted time period.

47. The method of claim 39, further comprising transmitting an alert to one or more administrators that access to the Internet service is disabled.

48. The method of claim 39, wherein the administrator is notified of any request made to access Internet content during a restricted time period.

49. The method of claim 39, wherein the administrator defines an exception list to maintain access to services providing voice communications over the network during a restricted time period.

50. The method of claim 39, wherein disabling access to the Internet service provided by the network includes disabling access to services providing data communications over the network.

51. The method of claim 39, further comprising presenting a notification screen stating that access to the Internet service is unavailable when a user attempts to access Internet content during a restricted time period.

52. The method of claim 39, wherein a history of restricted time periods and attempts to access Internet content during restricted time periods is stored and is accessible for processing, analysis, and reporting.

53. The method of claim 39, wherein the administrator sets different restriction policies for different locations.

54. The method of claim 39, wherein at least a portion of the Internet services resides on a user device.

55. A system to mediate access to an Internet service, the system comprising:
a user interface module to provide a user interface between at least one application user and an Internet service, the user interface being coupled with a DNS server; and
a request module coupled with the DNS server to receive instructions defining one or more restricted time periods during which access to the Internet service provided by a network is to be disabled, the instructions being provided by an administrator associated with the network, so that when a request is received from an application user via the user interface to access Internet content, the system determines whether the request is made during a restricted time period, and denies the request if the request is made during a restricted time period, and resolves the request if the request is made during an unrestricted time period.

56. The system of claim 55, wherein the administrator provides instructions from a mobile device.

57. The system of claim 56, wherein the mobile device is associated with a second network.

58. The system of claim 57, further comprising receiving information from a GPS component of the mobile device indicating the mobile device is remote from the network associated with the administrator.

59. The system of claim 55, wherein the restricted time periods repeat based on a time interval, the time interval being selected from among a day, a week, and a year.

60. The system of claim 55, wherein the administrator establishes restricted time periods with no advance notice.

61. The system of claim 55, wherein the administrator disables access to Internet content with no advance notice.

62. The system of claim 55, wherein the administrator allows access to the Internet service during a restricted time period.

63. The system of claim 55, further comprising transmitting an alert to one or more administrators that access to the Internet service is disabled.

64. The system of claim 55, wherein the administrator is notified of any request made to access Internet content during a restricted time period.

65. The system of claim 55, wherein the administrator defines an exception list to maintain access to services providing voice communications over the network during a restricted time period.

66. The system of claim 55, wherein disabling access to the Internet service provided by the network includes disabling access to services providing data communications over the network.

67. The system of claim 55, further comprising presenting a notification screen stating that access to the Internet service is unavailable when a user attempts to access Internet content during a restricted time period.

68. The system of claim 55, wherein a history of restricted time periods and attempts to access Internet content during restricted time periods is stored and is accessible for processing, analysis, and reporting.

69. The system of claim 55, wherein the administrator sets different restriction policies for different locations.

70. The system of claim 55, wherein at least a portion of the Internet service resides on a user device.
